(19) United States
(12) Patent Application Publication
(10) Pub. No.: US 2022/0149679 A1
(43) Pub. Date: May 12, 2022

(54) ELECTRICAL MACHINE, METHOD FOR PRODUCING A STATOR/HOUSING ARRANGEMENT FOR AN ELECTRICAL MACHINE, AND VEHICLE

(71) Applicant: Valeo Siemens eAutomotive Germany GmbH, Erlangen (DE)

(72) Inventors: Robert Werner, Bad Neustadt a.d.Saale (DE); Bernhard Kessler, Bad Neustadt a.d.Saale (DE)

(73) Assignee: Valeo Siemens eAutomotive Germany GmbH, Erlangen (DE)

(21) Appl. No.: 17/454,121

(22) Filed: Nov. 9, 2021

(30) Foreign Application Priority Data
Nov. 11, 2020 (DE) 10 2020 214 149.5

(51) Int. Cl. H02K 1/18; H02K 15/02

(52) U.S. Cl. CPC H02K 1/185; H02K 15/028

(57) ABSTRACT

A method for producing a stator/housing arrangement for an electrical machine (1) having a stator (5) and a housing (2), wherein a housing part (3, 3a . . . 3c) of the housing (2) has at least one circumferential housing slot (4, 4a . . . 4c) and a stator laminated core (6, 6a . . . 6c) of the stator (5) has at least one circumferential stator slot (9, 9a . . . 9c). Here, the stator laminated core (6, 6a . . . 6c) is placed or pressed into the housing part (3, 3a . . . 3c) in a position in which the stator slot (9, 9a . . . 9c) and the housing slot (4, 4a . . . 4c) have a region of intersection (B). Afterwards, a potting compound (15) is introduced into the stator slot (9, 9a . . . 9c) and the housing slot (4, 4a . . . 4c). Furthermore, the invention specifies an electrical machine (1) with a stator/housing arrangement having the properties specified above, and a vehicle (19) with such an electrical machine (1).

### TECHNICAL FIELD

The invention relates to an electrical machine, to a method for producing a stator/housing arrangement for an electrical machine, and to a vehicle with such an electrical machine.

### PRIOR ART

In electrical machines, it is known to press the stator laminated core into a housing part of the housing. In this case, the problem of a fit between said parts changing when they are not produced from the same material arises, particularly given a large range in respect of the use or operating temperature of the electrical machine. This is the case, for example, when the stator laminates of the stator laminated core consist of steel but the housing part consists of an aluminium alloy. Since aluminium expands to a greater extent than steel, the press fit becomes weaker upon heating of the electrical machine and becomes stronger upon cooling. In this respect, the problem that the stator laminated core slips through, that is to say undesired relative rotation occurs between the stator laminated core and the housing part, arises upon heating. The problem that the stator laminated core, under certain circumstances, pushes onto the housing part so powerfully that said housing part breaks arises once again upon cooling. The wall thickness of the housing part therefore has to be selected such that this does not happen, as a result of which the weight of the electrical machine is increased. Particularly when said electrical machine is used in a vehicle, this is a highly disadvantageous effect. In general, it is also disadvantageous that both the inner side of the housing part and also the outer side of the stator laminated core have to be produced with very small tolerances, with the result that the press fit between the stator laminated core and the housing part exhibits reproducible properties. In the given context, it is also conceivable to seek out suitable pairs from a large number of stator laminated cores and housing parts by measuring the inside diameter of the housing part and the outside diameter of the stator laminated core, this likewise requiring a great deal of effort.

It is also known to screw the stator laminated core to the housing or to arrange an interlocking element between the stator laminated core and the housing, for example a feather key. In this case too, establishing the connection between the stator laminated core and the housing requires a great deal of effort and it is necessary to provide a fit, even though less stringent demands may be placed on this fit. For the use of an interlocking element between the stator laminated core and housing, it is also necessary for the stator laminated core and the housing to be correctly oriented in relation to one another, that is to say to not be rotated with respect to one another. This places stringent demands on the production process since the stator laminated core firstly has to be pressed into the housing part of the housing, but secondly a correct angular position between the stator laminated core and the housing has to be complied with.

### DISCLOSURE OF THE INVENTION

An object of the invention is therefore to provide an improved electrical machine, an improved method for producing a stator/housing arrangement for an electrical machine, and an improved vehicle with such an electrical machine. In particular, the disadvantages mentioned above should be overcome. In particular, production of the electrical machine should be simplified, but at the same time rotation between the stator laminated core and the housing during operation of the electrical machine should be avoided.

The object of the invention is achieved by a method for producing a stator/housing arrangement for an electrical machine having a stator and a housing, which method comprises the following steps:
providing a housing part of the housing, which housing part has at least one circumferential housing slot which is open radially to the inside,
providing a stator laminated core of the stator, which stator laminated core has at least one circumferential stator slot which is open radially to the outside,
placing or pressing the stator laminated core into the housing part in a position in which the stator slot and the housing slot have a region of intersection or region of overlap, and
introducing a potting compound into a cavity which is formed by the stator slot and the housing slot, in particular by means of a tubular lance.

The object of the invention is furthermore achieved by an electrical machine which
comprises a housing with a housing part which has at least one circumferential housing slot which is open radially to the inside,
a stator which is arranged in the housing part and has a stator laminated core, wherein the stator laminated core has at least one circumferential stator slot which is open radially to the outside, and
a rotor which is arranged in the housing and is rotatably mounted therein.

Finally, the object is also achieved by a vehicle with at least two axles, of which at least one is driven, wherein said driving is performed at least partially or for part of the time by the abovementioned electrical machine.

The disadvantages cited at the outset may be overcome by means of the proposed measures. This is achieved by a potting compound which is introduced in liquid or pasty form into the volume which is formed by the stator slot and the housing slot, and consequently cures there. As a result, a specific angular position between the stator laminated core and the housing part does not have to be complied with in a particularly precise manner during production of the electrical machine since the potting compound in liquid or pasty form can be readily introduced even given an imprecise angular position between the stator laminated core and the housing part and can be readily matched to the cavity produced by the stator slot and the housing slot. Secondly, a fit between the stator laminated core and the housing part also does not have to be selected to be particularly narrow in order to prevent rotation between them since the potting compound in cured form creates an interlocking connection between the stator laminated core and the housing part and rotation between them during operation of the electrical machine is effectively prevented, even if a press fit between the stator laminated core and the housing part is intended to be loose. As a result, the housing part can be of relatively thin-walled configuration, this having a positive effect on the weight of the electrical machine and in particular facilitating use of said electrical machine in a vehicle.

Further advantageous refinements and developments of the invention can be found in the dependent claims and in the description considered in conjunction with the figures.

Advantageously, the stator slot is closed at one end of the stator laminated core and/or the housing slot is closed at one end of the housing part. In this way, the potting compound can be prevented from flowing out when it is introduced into the housing slot and the stator slot, even at high pressures that arise.

The stator laminated core advantageously comprises a plurality of stator laminates which are stacked one on the other and each have a circumferential recess which is open radially to the outside, which recesses together form the stator slot, wherein the stator slot
a) runs in the axial direction or
b) runs in the form of a helical line.
   In this embodiment, a recess which can be made, for example, by punching or laser cutting is provided during production of the individual stator laminates. When the stator laminates are stacked, the recesses of the stator laminates together create the stator slot in the stator laminated core. A different profile of the stator slot is created depending on whether the stator laminates are stacked congruently one on the other or are rotated with respect to one another. If the stator laminates are stacked congruently one on the other, a stator slot which runs in the axial direction (case a) is created. If the stator laminates are rotated with respect to one another during stacking, then a profile of the stator slot in the form of a helical line (case b) is created. In both cases, machining of the stator laminated core for producing the stator slot can be dispensed with. However, this is not precluded. In principle, the stator slot can also be produced, for example by milling, after the stator laminates are stacked.

It is furthermore expedient if the stator laminates are of identical shape, wherein the closure of the stator slot is implemented by rotating the stator laminates in the end region of the stator slot in relation to the stator laminates in the slot region of the stator slot. As a result, the stator slot can be closed at one end of the stator laminated core in a simple manner, without complicating production of the individual stator laminates.

It is also advantageous if the housing slot runs in the axial direction. In this way, the housing slot can be produced without problems during casting of the housing. Machining of the housing for producing the housing slot can then be dispensed with.

The potting compound advantageously consists of a plastic or a plastic composite material. The properties of plastics or plastic composite materials can be adjusted over a wide parameter range and therefore can be readily matched to the present object. A readily adjusted potting compound can therefore firstly be readily introduced into the cavity which is formed by the housing slot and the stator slot but, in the cured state, also meets the demands for stability, in particular in the case of severe temperature fluctuations and cyclical mechanical stress.

Finally, it is expedient if a press fit is provided between the stator laminated core and the housing part. In this way, a torque between the stator laminated core and the housing part can be transmitted at least partially or at least over a wide temperature range in a force-fitting manner. The potting compound then acts as additional security.

It should be noted at this point that the design variants cited for the electrical machine and the resulting advantages equally apply to the method for producing a stator/housing arrangement for an electrical machine.

The above refinements and developments of the invention may be combined in an arbitrary fashion.

### BRIEF DESCRIPTION OF THE FIGURES

Exemplary embodiments of the invention are illustrated as examples in the appended schematic figures, in which:

FIG. 1 shows a schematic half-sectional view of an exemplary electrical machine with a potting compound in the housing slot and in the stator slot;

FIG. 2 shows a front view of an example of a stator/housing arrangement with a rotation-prevention means with an elliptical cross section;

FIG. 3 shows a front view of an example of a stator/housing arrangement with a rotation-prevention means with a rectangular cross section;

FIG. 4 shows a front view of an example of a stator/housing arrangement with a rotation-prevention means with a circular cross section;

FIG. 5 shows an example of a stator/housing arrangement with a plurality of rotation-prevention means distributed over the periphery;

FIG. 6 shows a somewhat more detailed oblique view of a housing part;

FIG. 7 shows a somewhat more detailed oblique view of a stator;

FIGS. 8-11 show a possible course of events during the production of the stator/housing arrangement for the electrical machine;

FIGS. 12-15 show possible orientations of the housing slot and the stator slot, and

FIG. 16 shows a vehicle with an electrical machine of the disclosed type.

### DETAILED DESCRIPTION OF THE INVENTION

Initially, it is stated that identical parts in the different embodiments are provided with the same reference signs or the same component designations, in some cases with different indices. The disclosures of a component contained in the description may accordingly be transferred to another component with the same reference sign or the same component designation. Also, the positional data selected in the description, such as for example “top”, “bottom”, “rear”, “front”, “side” etc. relate to the figure directly described and illustrated, and in the event of a position change, should be transferred accordingly to the new position.

FIG. 1 shows a half-section through a schematically illustrated electrical machine 1. In this example, the electrical machine 1 comprises a housing 2 having a housing part 3 which has at least one circumferential housing slot 4 which is open radially to the inside, and a stator 5 which is arranged in the housing part 3 and has a stator laminated core 6 which has a plurality of stator laminates 7 which are arranged one behind the other and in which stator laminated core stator windings 8 are held. In addition, the stator laminated core 6 comprises at least one circumferential stator slot 9 which is open radially to the outside. The electrical machine 1 furthermore comprises a shaft 10 with a rotor 11, not illustrated in detail here, seated on it, wherein the shaft 10 is mounted by means of (rolling) bearings 12a, 12b so as to be rotatable about an axis of rotation A in relation to the stator 4. Specifically, the first bearing 12a sits in a front end plate 13, and the second bearing 12b sits in a rear end plate 14. The (central) housing part 3 connects the front end plate 13 and the rear end plate 14. In this example, the front end plate 13, the rear end plate 14 and the housing part 3 form the housing 2 of the electrical machine 1.

The stator laminated core 5 is arranged in the housing part 3 in a position in which the housing slot 4 and the stator slot 9 have a region of intersection or a region of overlap. That is to say, the volume of the housing slot 4 and the volume of the stator slot 9 are connected to one another. A potting compound 15, which is cohesive in said region of intersection, is introduced into the cavity which is formed by the housing slot 4 and the stator slot 9.

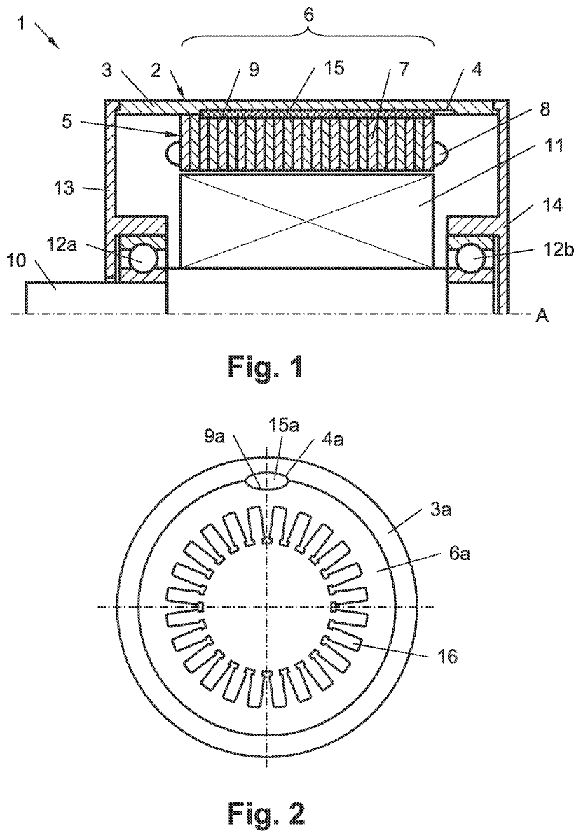

FIG. 2 shows a front view of a first example of a stator/housing arrangement which has a housing part 3a and a stator laminated core 6a of the abovementioned type. The stator windings 8 are not illustrated in FIG. 2, and for this reason the stator winding slots 16 are visible. Specifically, the stator/housing arrangement illustrated in FIG. 2 has a rotation-prevention means with an elliptical cross section, which rotation-prevention means is formed by the potting compound 15a, and a correspondingly shaped housing slot 4a and a correspondingly shaped stator slot 9a.

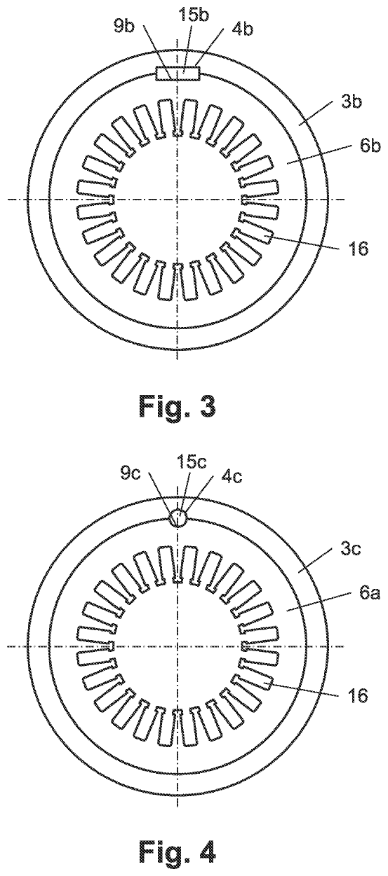

FIG. 3 shows a stator/housing arrangement which is very similar to the stator/housing arrangement illustrated in FIG. 2. In contrast thereto, the rotation-prevention means which is formed by the potting compound 15b has a rectangular cross section.

FIG. 4 shows a stator/housing arrangement which is likewise very similar to the stator/housing arrangement illustrated in FIG. 2. In contrast thereto, the rotation-prevention means which is formed by the potting compound 15c has a circular cross section.

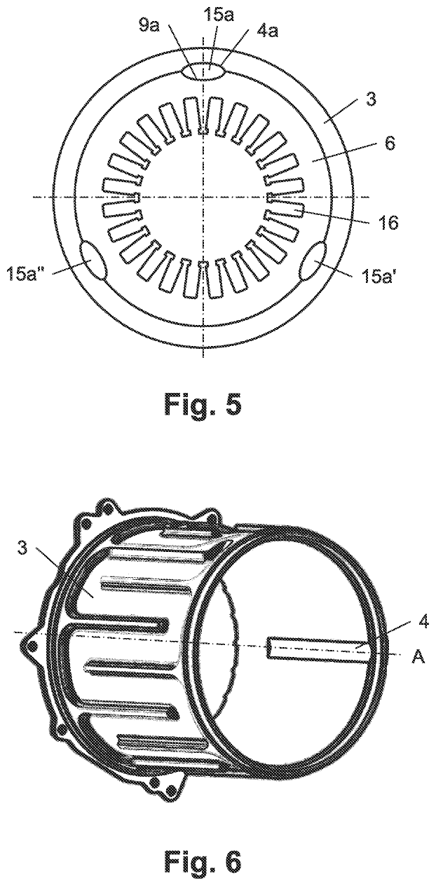

FIG. 5 finally also shows a further stator/housing arrangement which is very similar to the stator/housing arrangement illustrated in FIG. 2. However, in contrast thereto, three rotation-prevention means which have an elliptical cross section and are formed by the potting compounds 15a . . . 15a″ are arranged in a manner distributed over the periphery of the stator/housing arrangement. Specifically, these are respectively rotated through 120° in relation to one another.

It goes without saying that the elliptical cross section for the stator/housing arrangement illustrated in FIG. 5 is shown purely by way of example and other cross-sectional shapes are also possible. Cross-sectional shapes other than elliptical, circular or rectangular cross sections are, of course, also possible for individual rotation-prevention means, as are illustrated in FIGS. 2 to 4.

FIG. 6 now shows a somewhat more detailed oblique view of a housing part 3 with the housing slot 4 arranged in it.

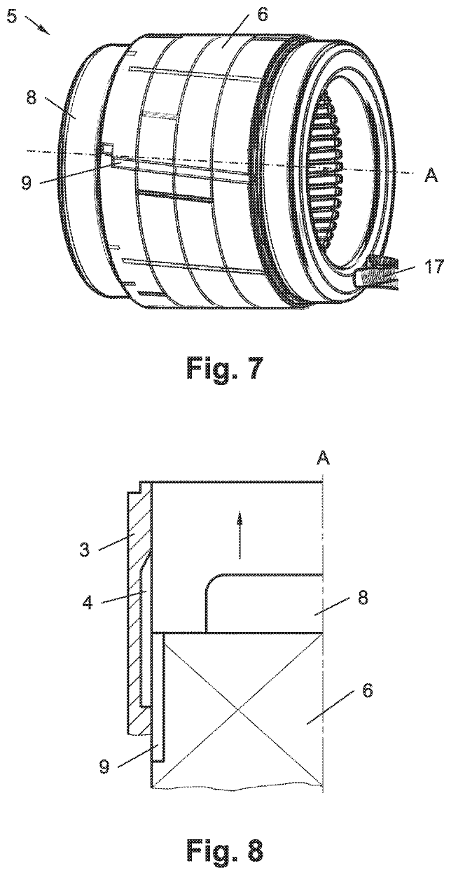

FIG. 7 furthermore shows a somewhat more detailed oblique view of a stator 5 with the stator slot 9 arranged on it. FIG. 7 furthermore shows connection cables 17 for the stator winding 8. In this example, closure of the stator slot 9 is established by rotating the stator laminates 7 in the end region of the stator slot 9 in relation to the stator laminates 7 in the slot region of the stator slot 9. As a result, the stator slot 9 can be closed at one end of the stator laminated core 6 in a simple manner. In this case, the stator laminates 7 can be of identical shape and so can be produced in an efficient manner. The rotation angle of the stator laminates 7 in the end region of the stator slot 9 in relation to the stator laminates 7 in the slot region of the stator slot 9 lies, in particular, in the region of an integer multiple of the angle between two adjacent stator winding slots 16. However, if the stator slot 9 runs obliquely or in the form of a helical line as here in this example, the rotation angle of the stator laminates 7 in the end region of the stator slot 9 in relation to the stator laminates 7 in the slot region of the stator slot 9 deviates to a certain extent from the angle mentioned above.

FIGS. 8 to 11 consequently show an exemplary course of events during the production of a stator/housing arrangement. In FIGS. 8 to 11, which each show a half-section of a detail of the stator/housing arrangement, the stator/housing arrangement is illustrated in a manner rotated through 90° in relation to FIG. 1 and is upright there. That is to say, the axis of rotation A is of vertical orientation.

In a first step, illustrated in FIG. 8, the stator laminated core 6 is pushed into the housing part 3 (see the direction of movement of the stator laminated core 6 illustrated by the arrow). A press fit is preferably provided between the stator laminated core 6 and the housing part 3. In the case illustrated in FIG. 8, the stator winding 8 is already wound into the stator slots 16 of the stator laminated core 6. Although this is advantageous, the stator winding 8 can, in principle, also be fitted at a later time.

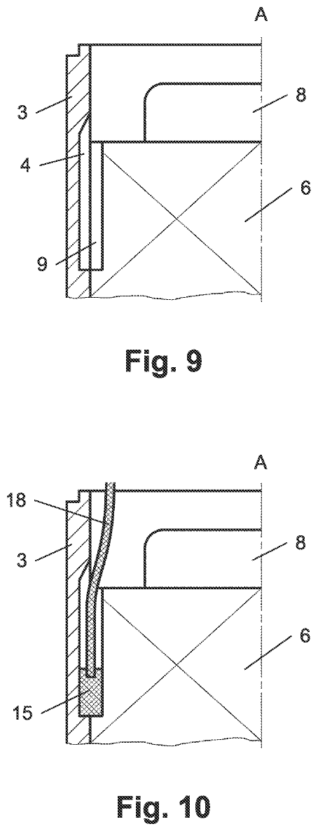

FIG. 9 shows a state in which the stator laminated core 6 has reached the end position in the housing part 3. In order to fix the position, the housing part 3 can also have an optional stop for the stator laminated core 6.

In the state illustrated in FIG. 10, the potting compound 15 is introduced into the stator slot 9 and the housing slot 4. In this case, this is done by means of a tubular lance 18 which can be of particularly flexible configuration. However, in principle, the potting compound 15 can also be introduced into the stator slot 9 and the housing slot 4 in a different way, for example by way of the interior of the stator/housing arrangement being flooded with the liquid potting compound 15, for example by immersing the stator/housing arrangement in a container which is filled with the liquid potting compound 15.

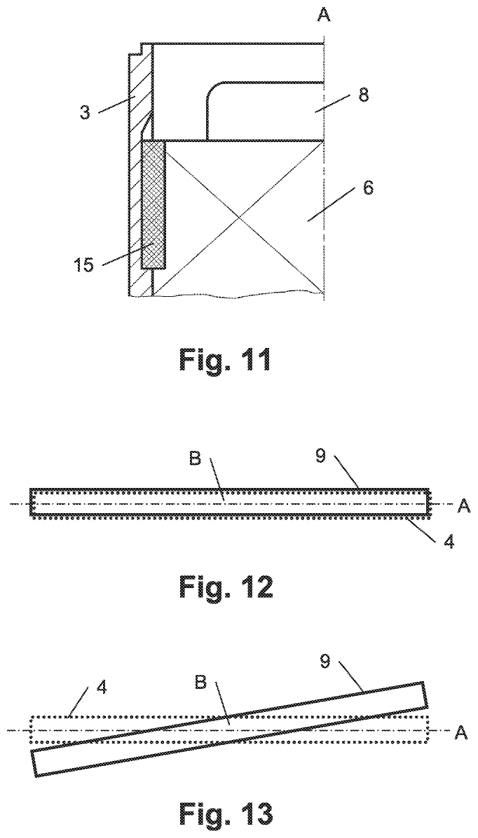

FIG. 11 finally shows a state in which the stator slot 9 and the housing slot 4 are completely filled with the potting compound 15 and the tubular lance 18 has been removed again. After this, the potting compound 15 is cured.

In summary, the method for producing the stator/housing arrangement for the electrical machine 1 comprises the steps of
providing a housing part 3 of the housing 2, which housing part has at least one circumferential housing slot 4 which is open radially to the inside,
providing a stator laminated core 6 of the stator 5, which stator laminated core has at least one circumferential stator slot 9 which is open radially to the outside,
placing or pressing the stator laminated core 6 into the housing part 3 in a position in which the housing slot 4 and the stator slot 9 have a region of intersection, and
introducing a potting compound 15 into a cavity which is formed by the housing slot 4 and the stator slot 9, in particular by means of a tubular lance 18.

FIGS. 12 to 15 now schematically show various orientations of the housing slot 4 and the stator slot 9 and the different regions of intersection B that result. Specifically, the housing slot 4, the stator slot 9 and the region of intersection B are each illustrated in side view. All the other components of the electrical machine 1 have been omitted from the illustrations of FIGS. 12 to 15 for reasons of improved clarity.

In FIG. 12, the housing slot 4 and the stator slot 9 are oriented parallel to the axis of rotation A. Therefore, a rectangular region of intersection B is created. Depending on the position of the housing slot 4 and the stator slot 9 in relation to one another, the rectangular region of intersection B may also be narrower if the housing slot 4 and the stator slot 9 are not oriented precisely in relation to one another.

In the example illustrated in FIG. 13, the housing slot 4 is oriented parallel to the axis of rotation A, whereas the stator slot 9 is oriented obliquely thereto. Accordingly, a diamond-shaped region of intersection B is created. Depending on the position of the housing slot 4 and the stator slot 9 in relation to one another, the axial position of the diamond-shaped region of intersection B can vary, but its size remains constant over a large region.

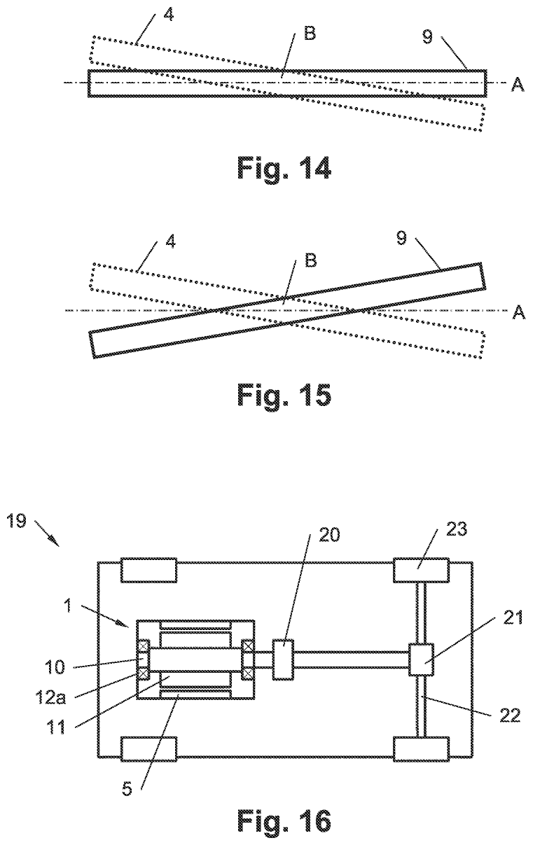

FIG. 14 shows an example which is very similar to the example illustrated in FIG. 13. However, in contrast thereto, the roles of the housing slot 4 and the stator slot 9 are reversed. However, the manner of operation is virtually identical.

FIG. 15 finally shows an example in which both the housing slot 4 and the stator slot 9 are oriented obliquely to the axis of rotation A. Once again, a diamond-shaped region of intersection B is created, it being possible to vary the axial position of said region of intersection depending on the position of the housing slot 4 and the stator slot 9 in relation to one another, but its size remaining constant over a large region.

It should be noted at this point that the housing slot 4 and the stator slot 9 can also be inclined in the same direction in relation to the axis of rotation A. If the angle of rotation is of the same magnitude, similar conditions to those in the example shown in FIG. 12 are created. If the angles of rotation are of different magnitude, similar conditions to those in FIG. 15 are created.

In the embodiments illustrated in FIGS. 1 and 6 to 11, the stator slot 9 is closed at one end of the stator laminated core 6, and the housing slot 4 is closed at one end of the housing part 3. In this way, the potting compound 15 can be prevented from flowing out when it is introduced into the housing slot 4 and the stator slot 9, even at high pressures that arise. Even though this embodiment provides advantages, it is nevertheless also possible for the stator slot 9 to be open at both ends of the stator laminated core 6 and/or for the housing slot 4 to be open at both ends of the housing part 3.

In the exemplary embodiment illustrated in FIG. 6, the housing slot 4 runs in the axial direction. In this way, the housing slot 4 can be produced without problems during casting of the housing part 3. Machining of the housing part 3 for producing the housing slot 4 can therefore be dispensed with. Even though this embodiment provides advantages, it is nevertheless also possible for the housing slot 4 to run obliquely or along a helical line.

The stator laminates 7 advantageously each comprise a circumferential recess which is open radially to the outside, which recesses together form the stator slot 9. In this case, the stator slot 9 can run in the axial direction if the stator laminates 7 are stacked congruently one on the other during production of the stator laminated core 6 (case a) or run along a helical line if the stator laminates 7 are rotated with respect to one another during production of the stator laminated core 6 (case b).

The recesses in the stator laminates 7 can be produced, for example, by punching or laser cutting. Machining of the stator laminated core 6 for producing the stator slot 9 can therefore be dispensed with. However, this is not precluded. In principle, the stator slot 9 can also be produced, for example by milling, after the stator laminates 7 are stacked. In particular, all of the stator laminates 7 can be of identical shape.

Furthermore, it is particularly advantageous if the housing slot 4 runs in the axial direction and the stator slot 9 runs along a helical line (also see FIG. 13). Therefore, the housing slot 4 and the stator slot 9 can—as already described above—be produced in a simple manner. Furthermore, a region of intersection B is created, the size of which is, in wide ranges, independent of rotation between the housing part 3 and the stator laminated core 6. Therefore, the rotation-prevention means exhibits properties which can be reproduced over a wide range together with particularly simple production of the electrical machine 1.

The potting compound 15 advantageously consists of a plastic or a plastic composite material. The properties of plastics or plastic composite materials can be adjusted over a wide parameter range and therefore can be readily matched to the present object. A readily adjusted potting compound 15 can therefore firstly be readily introduced into the housing slot 4 and into the stator slot 9 but, in the cured state, also meets the demands for stability, in particular in the case of severe temperature fluctuations and cyclical mechanical stress.

Rotation-prevention between the stator laminated core 6 and the housing part 3 can be established by means of the proposed measures, without excessively stringent demands being placed on the production process. This is achieved by the potting compound 15 which is introduced in liquid or pasty form into the stator slot 9 and the housing slot 4, and consequently cures there. As a result, a specific angular position between the stator laminated core 6 and the housing part 3 does not have to be complied with in a particularly precise manner during production of the electrical machine 1 since the potting compound 15 in liquid or pasty form can be readily introduced even given an inaccurate angular position between the stator laminated core 6 and the housing part 3 and can be readily matched to the cavity produced by the stator slot 9 and the housing slot 4. Secondly, a fit between the stator laminated core 6 and the housing part 3 also does not have to be selected to be particularly narrow in order to prevent rotation between them since the potting compound 15 in cured form creates an interlocking connection between the stator laminated core 6 and the housing part 3 and effectively prevents rotation between them, even if a press fit between the stator laminated core 6 and the housing part 3 is intended to be loose. As a result, the housing part 3 can be of relatively thin-walled configuration, this having a positive effect on the weight of the electrical machine 1 and in particular facilitating use of said electrical machine in a vehicle.

FIG. 16 finally shows the electrical machine 1 installed in a vehicle 19. The vehicle 19 has at least two axles, at least one of which is driven. Specifically, the electric motor 1 is connected to an optional gear mechanism 20 and a differential gear 21. The half-shafts 22 of the rear axle adjoin the differential gear 21. Finally, the driven wheels 23 are mounted on the half-shafts 22. Driving of the vehicle 19 is performed at least partially or for part of the time by the electrical machine 1. This means that the electrical machine 1 may serve for solely driving the vehicle 19, or for example may be provided in conjunction with an internal combustion engine (hybrid drive).

Finally, it is established that the scope of protection is determined by the patent claims. The description and the drawings should however be used to interpret the claims. The features contained in the figures may be interchanged and combined with one another in an arbitrary fashion. In particular, it is also noted that the devices illustrated may in reality also comprise more or else fewer component parts than illustrated. In some cases, the illustrated devices or their component parts may also not be illustrated to scale and/or may be increased in size and/or reduced in size.

1. A method for producing a stator/housing arrangement for an electrical machine having a stator and a housing, the method comprising:
providing a housing part of the housing, which housing part has at least one circumferential housing slot which is open radially to the inside;
providing a stator laminated core of the stator, which stator laminated core has at least one circumferential stator slot which is open radially to the outside;
placing or pressing the stator laminated core into the housing part in a position in which the housing slot and the stator slot have a region of intersection; and
introducing a potting compound into a cavity which is formed by the housing slot and the stator slot by a tubular lance.

2. An electrical machine, comprising:
a housing with a housing part which has at least one circumferential housing slot which is open radially to the inside,
a stator which is arranged in the housing part and has a stator laminated core, wherein the stator laminated core has at least one circumferential stator slot which is open radially to the outside, and
a rotor which is arranged in the housing and is rotatably mounted therein,
wherein the stator laminated core is arranged in the housing part in a position in which the housing slot and the stator slot have a region of intersection,
wherein a potting compound which is cohesive in said region of intersection is introduced into a cavity which is formed by the housing slot and the stator slot, and
wherein the stator laminated core and the housing part are part of a stator/housing arrangement which is produced in line with the method according to claim 1.

3. The electrical machine according to claim 2, wherein the stator slot is closed at one end of the stator laminated core, and/or in that the housing slot is closed at one end of the housing part.

4. The electrical machine according to claim 2, wherein the stator laminated core comprises a plurality of stator laminates which are stacked one on the other and each have a circumferential recess which is open radially to the outside, which recesses together form the stator slot, wherein the stator slot runs in the axial direction or runs in the form of a helical line.

5. The electrical machine according to claim 2, wherein the stator laminates are of identical shape, wherein the closure of the stator slot is implemented by rotating the stator laminates in the end region of the stator slot in relation to the stator laminates in the slot region of the stator slot.

6. The electrical machine according to claim 2, wherein the housing slot runs in the axial direction.

7. The electrical machine according to claim 2, wherein the potting compound consists of a plastic or a plastic composite material.

8. The electrical machine according to claim 2, wherein a press fit is provided between the stator laminated core and the housing part.

9. A vehicle with at least two axles, of which at least one is driven, wherein said driving is performed at least partially or for part of the time by the electrical machine according to claim 2.
